(19) United States
(12) Patent Application Publication
(10) Pub. No.: US 2008/0037267 A1
(43) Pub. Date: Feb. 14, 2008

(54) HEADLAMP ASSEMBLIES HAVING REDUCED OPERATING TEMPERATURES

(76) Inventors: Thomas O. Converse, Lanesborough, MA (US); James R. Wilson, Troy, MI (US)

Correspondence Address: SABIC - 08CT;SABIC Innovative Plastics - IP Legal, ONE PLASTICS AVENUE, PITTSFIELD, MA, 01201-3697, US

(21) Appl. No.: 11/838,292

(22) Filed: Aug. 14, 2007

Related U.S. Application Data
(60) Provisional application No. 60/822,268, filed on Aug. 14, 2006.

(51) Int. Cl. B60Q 1/04

(52) U.S. Cl. 362/510

(57) ABSTRACT

A headlamp assembly that utilizes a modified bulb shield and a lower heat deflection temperature plastic material for the construction of one or more components of the headlamp assembly. The components of the headlamp assembly that may be formed from the lower HDT plastic material include the reflector substrate, the housing, or a combination thereof. The modified bulb shield reduces the maximum temperature requirements of headlamp assemblies thereby enabling lower HDT plastic materials to be used in the headlamp assembly. The bulb shields are modified to reflect and/or transmit infrared (IR) energy that, if absorbed (at the bulb shield surface) would lead to localized heating of the headlamp reflector and the requirement that higher HDT plastic materials be used for the reflector substrate and/or housing of the headlamp assembly. The bulb shields may reflect and/or transmit IR energy using a reflective coating, an additive, and/or surface structures.

### CROSS REFERENCE TO RELATED APPLICATIONS

This application claims priority to U.S. Provisional Application No. 60/822,268, which was filed Aug. 14, 2006.

### FIELD OF INVENTION

The present invention relates to headlamp assemblies and, in particular, to headlamp assemblies having thermoplastic free-form reflectors and bulb shields.

### BACKGROUND OF INVENTION

Headlamp assemblies generally include a housing, a reflector in the housing, a headlamp bulb that is positioned in the reflector, a decorative bezel that generally surrounds the reflector and a clear lens. The free-form reflector has a generally parabolic shape that may also include facets of various shapes to aid in precisely reflecting light into a prescribed beam pattern. The optically active portion of the reflector is often surrounded by a non-active reflective surface that is largely aesthetic. The bulb is positioned such that its filament is approximately at the focal point of the generally parabolic free-form reflector. A bulb shield is often mounted to the reflector, and is positioned generally in front of the headlamp bulb. While the reflector functions to reflect the light from the headlamp bulb forward, which forms the headlamp beam, the bulb shield functions to prevent an oncoming driver from seeing a “hot spot” in the headlamp beam. In addition, the bulb shield generally functions to prevent light from striking areas of the headlamp reflector that are not optically active so that stray reflections (glare light) is prevented from being directed towards unintended or dark areas of the prescribed beam pattern.

Bulb shields typically include a cup portion that is disposed generally in front of the headlamp bulb, and a portion that extends from the cup portion and mounts to the reflector or some other proximate structure. The cup portion of the bulb shield is usually relatively sharply concave, thereby blocking light from the bulb that has not first struck an optically active portion of the reflector.

Due to the proximity of the bulb shield to the extremely high temperature bulb (Filament temperature approximately 3,000 degrees Centigrade), most bulb shields are constructed from metal materials. Since metallic surfaces are reflective and since reflections from the inner surface of the concave bulb shield will tend to be directed towards both optically active and optically non-active portions of the reflector and its surrounding structure, the inside surface of most bulb shields is coated with a heat resistant, non-reflective, black coating. At 3,000 degrees Centigrade, it is well known in the industry, from simple Boltzmann energy distribution calculations, that approximately 90% of the radiant energy from the bulb is in the infrared region of the electromagnetic spectrum. The non-reflective coatings employed on bulb shields are also effectively absorbent at infrared wavelengths. As a consequence, the bulb shield temperature reaches an even higher equilibrium temperature. The outer surface of these hot bulb shields are very close to other headlamp components, particularly the reflector, and drive sufficient secondary heating of proximate structures that only materials with high heat resistance can be employed. Currently, approximately 85% of free-form reflectors are constructed from metal or thermoset (BMC). However, these materials are difficult to form into desired shapes and are generally heavier, thereby resulting in motor vehicles that are heavier, which reduces the fuel efficiency of these vehicles.

Removing the bulb shield from the headlamp could reduce the temperature, and therefore the problems associated with the bulb shield. However, the bulb shield, (when employed) provides a shuttering or masking effect that prevents unwanted visible light rays from reaching unintended (decorative) reflective surfaces and being reflected in an uncontrolled manner (“Glare”). The overall distribution of visible light from a headlamp is heavily prescribed by NHTSA in FMVSS108 and it is often impossible to meet these requirements without a carefully designed bulb shield in place.

Accordingly, alternative materials have been suggested. Plastic was one possible alternative material. Plastic is a lightweight material and is relatively inexpensive. By reducing the weight of the vehicle, the fuel efficiency of the vehicle can be improved, which can be beneficial due to higher energy costs. In addition, components constructed from plastic can be more easily formed into a selected shape using conventional processes, such as an injection molding process in which complex shapes can be formed. Unfortunately, lower cost plastic materials generally cannot withstand very high temperatures. Accordingly, to construct one or more components of a headlamp assembly from a plastic material requires the use of plastic materials capable of withstanding the high temperatures found in headlamp assemblies. However, these higher temperature plastic materials are also generally more expensive and this higher cost can negate some or all of the advantages of using plastic materials in the headlamp assembly. In addition, choosing thermoplastic or thermosetting substrates for headlamp assemblies, with higher heat deflection temperature (HDT) characteristics, can also carry significant penalties in terms of mechanical properties and flow characteristics. In addition, the use of thermoset materials also result in the requirement for secondary processing steps as well as using a material that is not recyclable.

Accordingly, it would be beneficial to provide one or more components in the headlamp assembly that is at least partly formed using a lower cost, lower temperature thermoplastic material.

### SUMMARY OF THE INVENTION

The present invention provides a headlamp assembly utilizing a lower HDT plastic material for the construction of one or more components of the headlamp assembly. The components of the headlamp assembly that may be formed from the lower HDT plastic material include the reflector substrate, the housing, or a combination thereof. The present invention is able to use these lower HDT plastic materials through the use of a modified bulb shield that reduces the temperature requirements of headlamp assemblies. The bulb shields are modified to reflect and/or transmit infrared (IR) energy that, if absorbed (at the bulb shield surface) would lead to localized heating of the headlamp reflector and the requirement that higher HDT, higher cost reflector substrates be utilized.

Accordingly, in one aspect, the present invention provides a headlamp assembly that includes a reflector substrate, a bulb that is positioned in the reflector substrate, and a bulb shield mounted to the reflector substrate and positioned generally in front of the bulb. The reflector substrate is constructed from a material having a heat deflection temperature of less than 210° C. at 0.45 MPa and the bulb shield is constructed and arranged to absorb less than 20% of infrared light directed towards the bulb shield while blocking at least 90% of visible light directed towards the bulb shield.

### BRIEF DESCRIPTION OF THE DRAWINGS

FIG. 1 is a blown up view of a headlamp assembly according to one embodiment of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention provides a novel headlamp assembly that includes a lower heat deflection temperature (HDT) plastic material for the construction of one or more components of the headlamp assembly. These components may include the reflector substrate, the housing, or any other component that previously required high HDT materials to be used. The present invention is able to use these lower HDT plastic materials through the use of a modified bulb shield that reduces the temperature inside the headlamp assembly and/or reduces the formation of hot spots in the headlamp assembly. The bulb shields are modified to reflect and/or transmit infrared (IR) energy that, if absorbed would lead to localized heating of the headlamp reflector and/or other areas inside the headlamp assembly. By eliminating these areas of localized heating (“hot spots”), lower HDT materials can be used in the headlamp assembly.

Since prior art headlamp reflectors have been constructed from BMC thermoset or high-heat, higher cost engineering thermoplastics, the present invention shows that by employing a bulb-shield that is substantially transparent to infrared (IR) energy, or substantially reflective of infrared energy, that lower heat, lower cost plastic materials may be used in the headlamp housing and/or the headlamp reflector substrates, thereby providing an alternative to higher cost, higher heat thermoplastic materials.

The present invention was created using various analyses of headlamp assemblies. It was observed through finite element analysis of headlamp assemblies that the primary mechanism by which the hottest portions of a headlamp reflector become heated was through convection. More specifically, analysis of convective velocity vectors in a headlamp through computational fluid dynamics (CFD) showed that the heated bulb shield was the “engine” that drives a vertical plume of superheated air that impinged on the headlamp reflector or in some designs on a combination reflector-housing or in some designs on a decorative bezel. Repeated CFD analysis and experimental measurements indicated that it was this spot on the reflector, located directly above the bulb shield, which exhibited the highest temperature and which was the first spot to “fail” if the reflector substrate HDT was not adequate.

It was also observed throughout repeated investigations and thermal simulations, that the areas on reflector and bezel components that required the highest heat resistance were relatively confined. Temperature measurements in adjacent areas of the headlamp reflector decreased sharply as one moved away from the “hot spot”.

Accordingly, by eliminating the hot spot, it would be possible to enable lower HDT materials to be used for the reflector substrate, or other headlamp assembly components such as a combination reflector/housing or a decorative bezel. Nevertheless, the option of removing the bulb shield is not practical. Given their function as a stray-light mask, an additional feature of bulb shields is that the inner surface of the bulb shield is designed to absorb light in the visible spectrum since stray reflections from the bulb shield would be as troublesome as unmasked light-rays.

It is known that the bulk of the energy emanating from a halogen bulb or a HID bulb is contained in the infrared spectrum. In general, less than 10% of the energy from a 55-watt halogen bulb is in the visible spectrum. Accordingly, since this infrared light from the bulb causes the heating of the bulb shield, the present invention helps solve the problem of localized heating and attempts to lessen this heating by preventing this infrared light from being absorbed (either through reflection or transmission of the infrared spectral component) by the bulb shield. As such, the headlamp assemblies of the present invention reduce the bulb shield temperature, and hence the headlamp reflector hot spot. By reducing the temperature of the bulb shield, the maximum temperature on the reflector, and on other components inside the headlamp assembly in general, is reduced. This lower temperature then enables the use of lower HDT headlamp reflector substrates, which are cheaper and which generally have enhanced mechanical properties and flow characteristics than higher HDT substrates.

Accordingly, the present invention overcomes the problems of the prior art that prevented the use of low HDT plastic materials for the reflector substrate through the use of a bulb shield that prevents IR absorption but while still being capable of blocking visible light to prevent unmasked light-rays. The present invention accomplishes this through the use of a bulb shield that is substantially transparent or reflective to infrared light while also being substantially opaque to visible light. As used herein, “substantially transparent or reflective to infrared light” refers to a bulb shield that, in one embodiment, absorbs less than 20% of infrared light directed thereto. In another embodiment, the bulb shield absorbs less than 10% of infrared light directed thereto. In still another embodiment, the bulb shield absorbs less than 5% of infrared light directed thereto. The infrared light that is not absorbed may either be passed through the bulb shield or may be reflected by the bulb shield.

In addition being substantially transparent or reflective to infrared light, the bulb shield is also substantially opaque to visible light. As used herein, “substantially opaque to visible light” refers to a bulb shield that, in one embodiment, blocks or absorbs at least 80% of the visible light directed thereto. In another embodiment, the bulb shield blocks or absorbs at least 90% of the visible light directed thereto. In still another embodiment, the bulb shield blocks or absorbs at least 95% of the visible light directed thereto.

Accordingly, the bulb shields used in the present invention can be constructed in any manner and from any material that enables the resulting bulb shield to be substantially transparent or reflective to infrared light while also being substantially opaque to visible light. In one embodiment, the bulb shield is constructed from a metal material that includes an IR reflective coating on at least a portion of one surface of the bulb shield. As such, the metal material substantially blocks visible light while the IR reflective coating reflects substantially all of the IR energy, thereby making the bulb shield substantially transparent or reflective to infrared light.

In an alternative embodiment, the bulb shield is constructed from a plastic material. The material itself may be selected to be substantially transparent or reflective to infrared light while also being substantially opaque to visible light. One example of such a material is LEXAN® 134R material to which a dye color of 21092 is added. This material is a polycarbonate-based material available from General Electric Co. (Pittsfield, Mass.). In another embodiment, the bulb shield is constructed from a plastic material that includes an IR transparent/visible light blocking coating on a least a portion of the bulb shield. In still another embodiment, the bulb shield is constructed from a plastic material that includes an IR reflecting additive therein. In yet another embodiment, the bulb shield is constructed from a plastic material that includes an IR reflecting coating on a least a portion of the bulb shield. In still another embodiment, the bulb shield is constructed from a plastic material that includes an IR reflecting additive therein and in addition thereto includes an IR reflecting coating on a least a portion of the bulb shield. In yet another embodiment, the bulb shield is constructed from a plastic material and includes one or more structural color features that are designed to reflect visible light and pass infrared light. In still another embodiment, the bulb shield is constructed from a plastic material that is molded with surface structures that substantially reflect infrared light. In still another embodiment, the bulb shield is constructed from a plastic material that is substantially transparent to infrared light and is molded with surface structures that aid in absorbing visible light. In yet another embodiment, the bulb shield is constructed from a plastic material that is coated, the coating having surface structures that substantially reflect infrared light. In still another embodiment, the bulb shield is constructed from a plastic material that is substantially transparent to infrared light and is coated, said coating having surface structures that aid in absorbing visible light.

In still another alternative embodiment, the bulb shield is constructed from a glass material. The glass material itself may be selected to be substantially transparent to infrared light while also being substantially opaque to visible light. Alternatively, the glass may include an IR reflecting additive and/or an IR reflecting coating on at least a portion of the surface of the bulb shield.

In addition to a bulb shield that is substantially transparent to infrared light while also being substantially opaque to visible light, the headlamp assemblies of the present invention also provide a reflector substrate that is constructed from a lower temperature plastic material. As used herein, a “lower temperature plastic material” includes, in one embodiment, a plastic material having a heat deflection temperature HDT @0.45 MPa of less than 210° C. In another embodiment, the plastic material has an HDT @0.45 MPa of less than 200° C. In still another embodiment, the plastic material has an HDT @0.45 MPa of less than 180° C.

Examples of lower temperature plastic materials that may be used in the present invention include, but are not limited to, co polycarbonate and copolycarbonate blends (LEXAN® and LEXAN® XHT resins commercially available from General Electric Company), acrylonitrile-butadiene-styrene (ABS), polycarbonate (LEXAN® and LEXAN® EXL resins commercially available from General Electric Company), polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide (NORYL GTX® resins from General Electric Company), blends of polycarbonate/polyethylene terephthalate (PET)/polybutylene terephthalate (PBT), polybutylene terephthalate and impact modifier (XENOY® resins commercially available from General Electric Company), polyamides, phenylene sulfide resins, polyvinyl chloride (PVC), high impact polystyrene (HIPS), low/high density polyethylene, polypropylene and thermoplastic olefins (TPO), polyethylene and fiber composites, polypropylene and fiber composites such as AZDEL Superlite™ sheets commercially available from AZDEL, Inc, or combinations thereof.

Also, while the reflector substrate is described as being constructed from a lower temperature plastic material, it is to be understood that other components, such as the housing, bezels or the like may also be constructed from lower temperature plastic materials. In addition, in an alternative embodiment, the reflector substrate is constructed from a thermoset material.

The headlamp assemblies of the present invention may utilize any light bulb capable of being used in a headlamp assembly. Examples of light bulbs that may be used include, but are not limited to, halogen bulbs or discharge bulbs (also called an HID or high intensity discharge bulb)

The foregoing and other features of the present invention will be more readily apparent from the following detailed description and drawing of one illustrative embodiment of the invention.

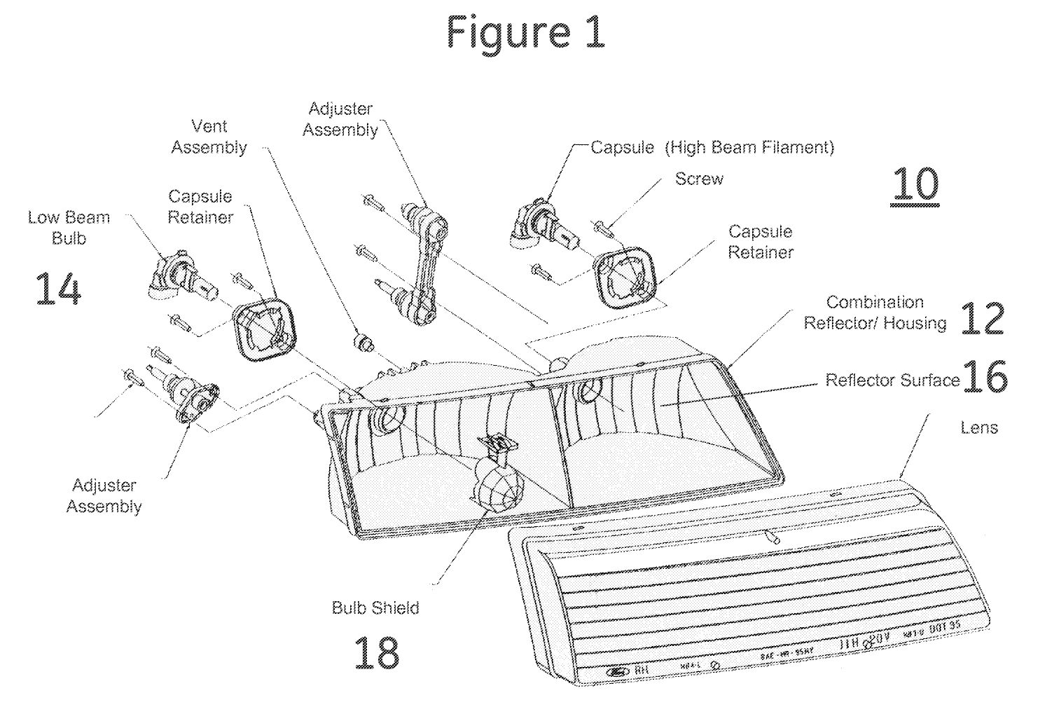

Referring to the drawing, FIG. 1 provides one embodiment of a headlamp assembly according to the present invention. In this embodiment, the headlamp assembly 10 includes a housing 12 that includes a light bulb 14 connected thereto. The housing 12 includes a reflective substrate 16 on an inner portion of the housing. The housing 12 and reflective substrate 16 can be, in one embodiment, constructed from the same plastic material and/or be one piece. Alternatively, in another embodiment, the housing 12 and reflective substrate 16 are constructed from different materials and/or are formed from two or more pieces. The headlamp assembly includes a bulb shield 18 that is positioned generally in front of the bulb 14 and is constructed and arranged to be substantially transparent or substantially reflecting to infrared light while also being substantially opaque to visible light.

All cited patents, patent applications, and other references are incorporated herein by reference in their entirety. The following examples, which are meant to be exemplary, not limiting, illustrate the inventive aspects of some of the various embodiments of the headlamp assemblies described herein.

### EXAMPLES

A Computational Fluid Dynamics (CFD) analysis of a Ford C307 (Ford Focus) headlamp indicated that replacing the black coating on the inner surface of a bulb shield with a reflective coating reduced the bulb shield temperature by 28-30° C. while only increasing the lens temperature by 2° C.

Another empirical study documents wherein the black coating on the inside of a bulb-shield on a C307 (Ford Focus) model headlamp was removed. In this study, it was discovered that removing the black coating (exposing a highly reflective steel surface underneath) reduced the temperature of the bulb shield and reduced the temperature of the headlamp reflector hot spot by about 20° C. As such, this study showed that by reducing the IR absorption of a bulb shield, a significant temperature drop could be achieved such that lower temperature plastic materials could be used for the reflector substrate and/or the housing of the headlamp assembly.

It should also be apparent to those skilled in the art that the concepts of the present invention can not only be used to enable the use of reflector substrates with lower HDT, but also has the ability to extend the applicability of higher HDT thermoplastics to replace metal or thermoset (BMC) in more thermally challenging designs wherein those materials are currently not capable of being utilized but would be able to be utilized if infrared light were not absorbed by the bulb shield.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A headlamp assembly comprising;
a reflector substrate,
a bulb that is positioned in the reflector substrate, and
a bulb shield mounted to the reflector substrate and positioned generally in front of the bulb;
wherein the reflector substrate is constructed from a material having a heat deflection temperature @ 0.45 MPa of less than 210° C.;
wherein the bulb shield is constructed and arranged to absorb less than 20% of infrared light directed towards the bulb shield while blocking at least 80% of visible light directed towards the bulb shield.

2. The headlamp assembly of claim 1, wherein the reflector substrate is constructed from a material having a heat deflection temperature @0.45 MPa of less than 180° C.

3. The headlamp assembly of claim 1, wherein the reflector substrate comprises a thermoplastic material and a metallic reflective coating.

4. The headlamp assembly of claim 1, wherein the bulb is a halogen bulb or a high intensity discharge bulb.

5. The headlamp assembly of claim 1, wherein the bulb shield is constructed and arranged to absorb less than 10% of infrared light directed towards the bulb shield.

6. The headlamp assembly of claim 1, wherein the bulb shield includes at least one additive capable of reflecting infrared light.

7. The headlamp assembly of claim 1, wherein the bulb shield is constructed from a substrate that is substantially transparent to infrared light but that is substantially opaque to light in the visible spectrum.

8. The headlamp assembly of claim 1, wherein the bulb shield includes an infrared reflective coating on at least a portion of a surface of the bulb shield.

9. The headlamp assembly of claim 8, wherein the bulb shield includes at least one additive capable of reflecting infrared light.

10. The headlamp assembly of claim 1, wherein the bulb shield comprises a plastic material.

11. The headlamp assembly of claim 1, wherein the reflector substrate comprises a thermoset material and a metallic reflective coating.

12. The headlamp assembly of claim 1, wherein the bulb shield is constructed from a material that is substantially transparent to infrared light and is molded with surface structures that aid in absorbing visible light.

13. The headlamp assembly of claim 1, wherein the bulb shield is constructed from a material that is substantially transparent to infrared light and further includes colorants that substantially absorb visible light.

14. The headlamp assembly of claim 1, wherein the bulb shield is constructed from a material that is substantially transparent to infrared light and is coated, said coating having surface structures that aid in absorbing visible light.

15. The headlamp assembly of claim 1, wherein the bulb shield is constructed from a material that is molded with surface structures that substantially reflect infrared light.

16. The headlamp assembly of claim 1, wherein the bulb shield is constructed from a material that is coated, said coating having surface structures that substantially reflect infrared light.
